(19) United States
(12) Patent Application Publication
(10) Pub. No.: US 2018/0207779 A1
(43) Pub. Date: Jul. 26, 2018

(54) FASTENER MAGAZINE RELEASE SYSTEM

(71) Applicant: WORKTOOLS, INC., Chatsworth, CA (US)

(72) Inventor: Joel S. Marks, Sherman Oaks, CA (US)

(73) Assignee: WORKTOOLS, INC., CHATSWORTH, CA (US)

(21) Appl. No.: 15/411,931

(22) Filed: Jan. 20, 2017

(51) Int. Cl. B25C 5/16; B25C 5/06

(52) U.S. Cl. CPC B25C 5/1696; B25C 5/06

(57) ABSTRACT

A track release system for a fastening tool such as a staple gun that may be exposed and operated substantially from under the tool. A track pull and selectively linked operative features are preferably fitted near a rear of a track. A user normally turns the tool upside down to access the track pull features for reloading fasteners. The track pull and associated elements are not exposed on a side of the tool body but rather on the rear and bottom. While the track release structure is below the track, the enabling structure remains vertically compact whereby the size of the tool need not be extended downward to accommodate the operative elements.

### FIELD OF THE INVENTION

The present invention relates to fastener storage. More precisely, the invention relates to improvements in a lock and release structure of a magazine in a fastening tool or device.

### BACKGROUND

Fastening devices include a tool which dispenses and installs fasteners into a work piece. A track, magazine or similar feature of the tool stores the fasteners for use. The fasteners are advanced toward a working end of the tool and expelled out of the tool to be installed in the work piece. An example of such a tool is a staple gun, wherein a track or magazine holds a rack of staples. The track may be opened to refill the magazine or change the type of staple or fastener on the track.

In one type of fastener storage system, a holding structure for the fastening device holds the track in its operative position under the fastener device's body. The holding structure is released to allow the track to move out to allow staples or other fasteners to be loaded into the device. The track is moved lengthwise outward to expose a track chamber at the bottom of the tool. In one form, a track pull is attached to a rear of the track and is pulled to slide the track open and pushed to close the track. The holding structure may be a latch that is operated to release the track. With a bottom loading system, it can be confusing to a user where or how the staples are loaded, and when opened with the tool upside right, staples can unintentionally fall out.

### SUMMARY OF THE INVENTION

The present invention in a preferred embodiment is directed to a track release system that may be exposed and operated substantially from under a fastening tool, such as a staple gun for example. The track pull and selectively linked operative features are preferably fitted near a rear of a track. A user normally turns the tool upside down to access the track pull features. Once the track is opened, the track chamber is directly visible and accessible. A user is then informed about where to load staples or other fasteners. Preferably, the track pull and associated elements are not exposed on a side of the tool body, but rather on the rear and bottom. This keeps a clean look to the tool, helps direct the user to the bottom of the tool, and minimizes distractions at the rear. While the track release structure is below the track, the enabling structure remains vertically compact wherein the size of the tool need not be extended downward to accommodate the operative elements.

### BRIEF DESCRIPTION OF THE DRAWINGS

FIG. 1 is a rear perspective view of a preferred embodiment fastening tool with an improved track release system.

FIG. 2 is a cropped, bottom rear perspective view of the fastening tool of FIG. 1.

FIG. 3 is a detail view of a rear portion of a fastening tool housing.

FIG. 4 is a rear perspective detail view of the fastening tool with track stowed.

FIG. 4A is a detail view of the rear portion of the track from FIG. 4.

FIG. 5 is a bottom perspective view of the tool of FIG. 4 with the track extended and with the tool flipped upside down as it is normally held for fastener loading.

FIG. 6 is a detail view of a track pull assembly in a closed latched rest position.

FIG. 7 is the view of FIG. 6 with the latch deflected to be released.

FIG. 8 is the view of FIG. 6 with the track partly pulled outward.

FIG. 9 is the view of FIG. 6 with the track forced rearward representing a staple jam.

FIG. 10 is an exploded view of components of a preferred embodiment track pull and release assembly.

FIG. 11 is a side elevational view of a track assembly in a closed latched condition.

FIG. 11A is a perspective view of an assembly of a release button and bias open slide.

FIG. 12 is the side elevational view of FIG. 11 with a release button pressed and latch deflected.

FIG. 13 is the side elevational view of FIG. 11 with the track partly extended to its open position.

FIG. 14 is a rear perspective view of a preferred embodiment track assembly.

### DETAILED DESCRIPTION OF THE PREFERRED EMBODIMENTS

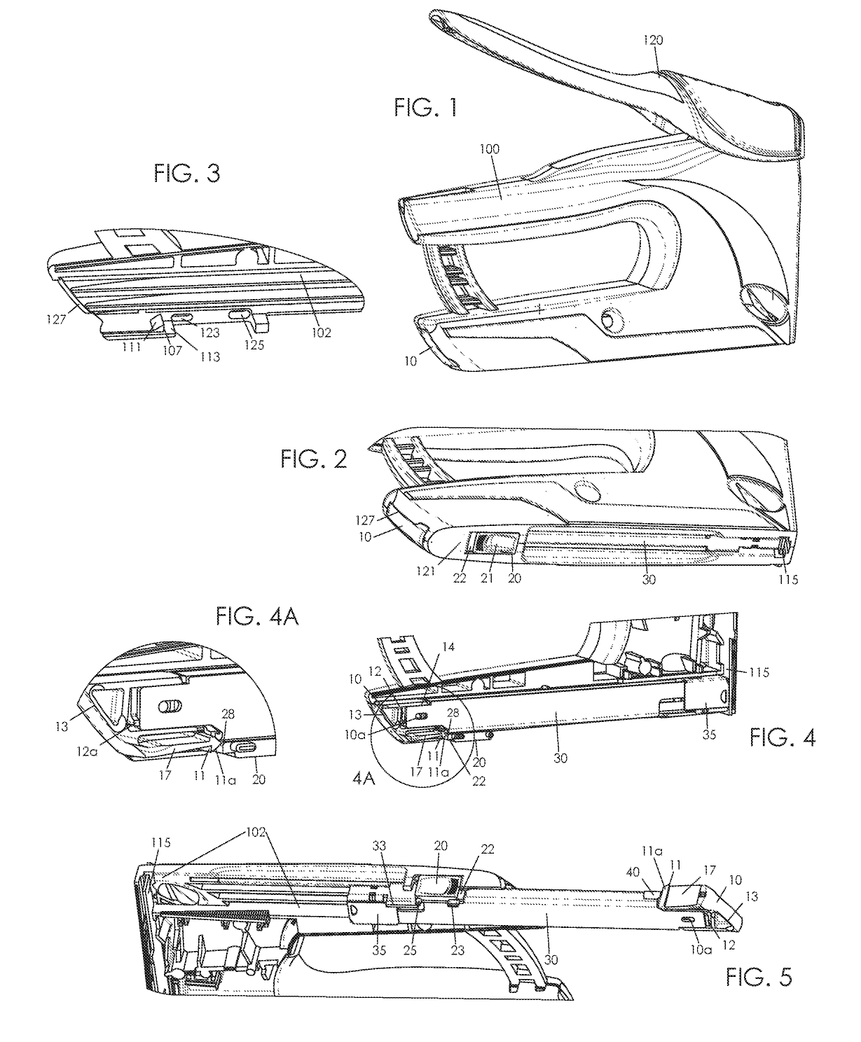

FIG. 1 shows a preferred embodiment fastening tool, which in this example is a manual, spring powered staple gun. Other fastening tools, devices and types of devices with a moving component that is selectively locked and released are contemplated and may include features of the present invention. In FIG. 1, handle 120 pivots about housing body 100 to operate the exemplary staple gun. Track pull 10 is visible at a rear of the tool. Preferably as shown, the track pull 10 and associated components are not exposed on the sides of the tool although they may optionally be so. For example, track pull 10 may extend width-wise to or past a face of the tool body sides. In FIG. 2, track pull 10 is shown within opening 127 of body 100. As seen in FIGS. 2 and 4, track pull 10 is preferably attached to a rear of track 30. It provides a closure to the end of the track 30 and multiple further functions described below.

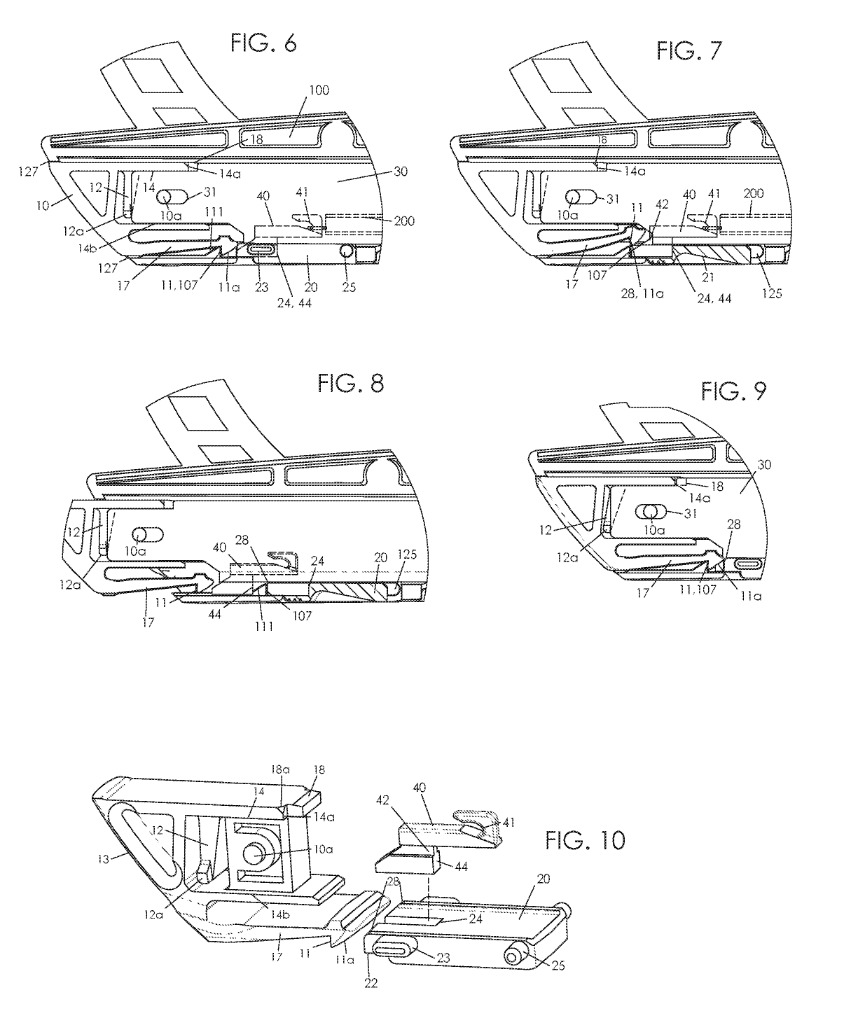

Track pull 10 is normally latched to the housing 100 by resilient latch arm 17 at catch 11, in FIG. 4. The catch 11 selectively engages the housing at front mating side rib 107 of cam ramp 111, see FIG. 3. Catch 11 may equivalently engage other structures that are linked or connected to the housing. To close the track 30, the rear of track pull 10 is pushed forward as cam face 11a (FIG. 6) rides up cam ramp 111 until catch 11 snaps against rib 107 under the resilient action of arm 17. As seen in FIG. 6, the rear of track pull 10 protrudes slightly past the rear end of housing 100 as defined at opening 127. This small protrusion ensures that the soft palm of a user's hand can easily press the track forward against the rear of housing 100. Latch arm 17 is resilient and is preferably made of the same molded piece as track pull 10.

In FIG. 6, a release pushbutton 20 is slidably fitted to the bottom of housing 100 and normally operated from a button interface location entirely below the track 30 (FIG. 4), although incidental interface parts of the button 20 may extend to higher positions. This button 20 or equivalent element disengages catch 11 from rib 107, FIG. 6. Exemplary embodiment release button 20 is separately movable from track pull 10. Recess 21 of the button 20 (FIG. 7) allows a user's finger to engage button 20 to press it inward and rearward and is the normal exemplary interface in the illustrated embodiment. Inward, in this case, is upward in FIG. 1, and down in the inverted position of FIG. 5, both being inward toward track chamber 102. Tab 22 (FIGS. 2, 5, 10) guides the button 20 on housing 100 and hides internal structure above. As seen in FIG. 6, the combination of button 20, latch arm 17, catch 11 and other associated elements, fits into a small vertical space below track 30. Latch arm 17 is preferably at least partly enclosed from below by housing 100 as shown.

Button 20 is accessed primarily from under the housing, as seen in the inverted housing position in FIG. 5. In particular, the button 20 or equivalent structure is exposed and operable from underneath the tool body. Preferably, the operable release button 20 is not substantially visible or usable from either a rear, side, or top of the tool. Rather, preferably the operable features of the button 20 are visible exclusively from a bottom view of the fastening tool, as seen in the bottom perspective view of FIGS. 2 and 5. Preferably, button 20 is spaced forward of a rear extent of the housing as shown FIG. 2 to help ensure it is not normally operable from the rear, or at least not visible except when operated with a view of the bottom. There may be some incidental portions of the operable button 20 that can be seen from other than the bottom face, but the button cannot be normally or conveniently operated from these alternative positions or faces of the tool since such operable features are absent from either of the sides or rear face of the tool. As seen in FIGS. 1 and 2, the rear face of the body 100 includes opening 127 and a rear end of track pull 10. Track pull 10 preferably cannot be released from any operation on or near its rear face. The sides of the tool body 100 preferably have no track assembly components for a sleek appearance as well as minimizing snagging while worn on a tool belt or in use.

To release the track 30 to become free to slide out, arm 17 is flexed out of engagement with rib 107, with such flexing being upward as illustrated in FIG. 7. Button 20 includes the actuated rear position wherein cam corner 28 (FIGS. 4A, 10) slidably presses cam face 11a to deflect arm 17 to the position shown in FIG. 7. Catch 11 is now free of housing rib 107. The force of cam corner 28 against cam face 11a biases the track 30 to move outward (to the left in most of the drawing figures) to the pop-out position of FIG. 8. As cam face 11a rides down cam ramp 111, track 30 will move outward as depicted in FIG. 8 to FIG. 9. In the instance when fasteners such as staples are loaded on track 30 in front of spring-biased staple pusher 35 (FIG. 4), the pusher will force the staples against striker 115 or other front termination of track chamber 102 as seen in FIG. 5. For example, track 30 may be opened with staples still remaining if the staple size is to be changed by the user. Pusher spring 200 provides the bias to pusher 35, FIG. 13. This force strongly urges the released track 30 rearward so that it pops out to allow easy grasping and further pulling of track pull 10 to a rear most position as in FIG. 5. Optional track feet 33 may guide and support track 30 inside track chamber 102. In FIG. 5, the tool is shown with the bottom facing upward in the normal staple loading position. Staples on a staple rack can then be conveniently loaded, i.e., dropped, into chamber 102.

As seen in FIG. 8, button 20 remains in its rearward slid position. It may be relatively loosely held as shown with the track 30 extended. As the track 30 is pressed back to its stowed position of FIG. 6, one of bias slide 40 and cam face 11a will push the button 20 to its forward corresponding stowed position.

When the track 30 is to be opened with no fasteners remaining, there will be little or no bias from pusher 35 to pop out the track. The primary force to move the track out is the cam face 11a to cam ramp 111 engagement discussed above. It is desirable to supplement this force to ensure the track 30 moves out far enough that it can be grasped to move to its rear extent. Therefore, an optional secondary spring or biasing means is preferably provided. In the exemplary embodiment, this secondary spring bias is supplied from pusher spring 200.

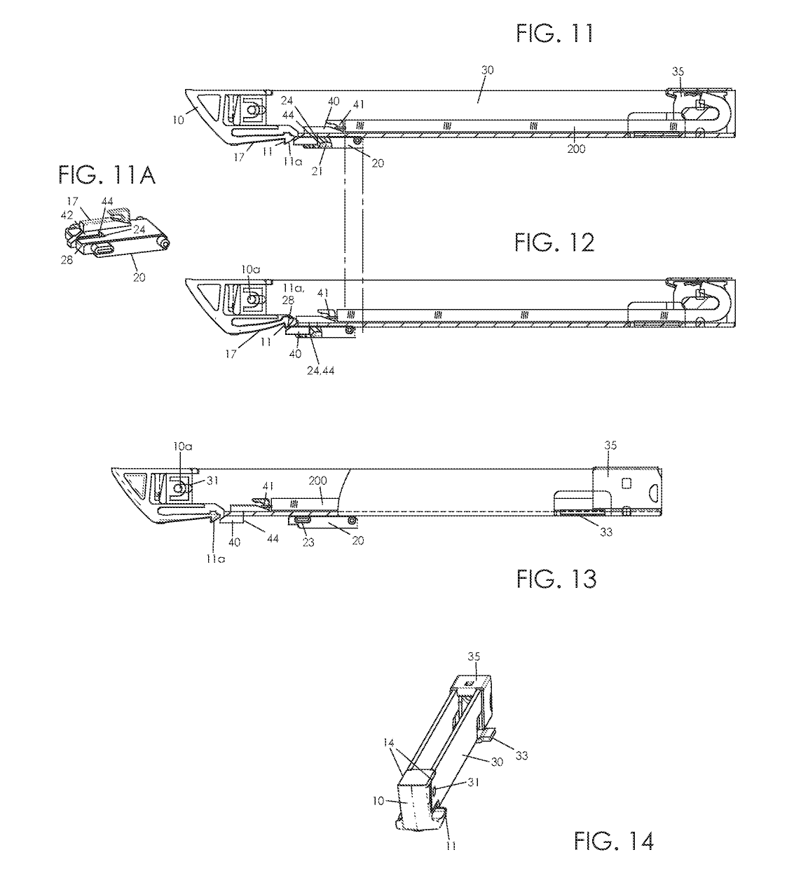

This operational sequence is shown in FIGS. 11 to 13. FIG. 11 shows the stowed position. Button 20 is partly cut away to show recess 21 and face 24. See also FIGS. 10 and 11A. Button 20 is slidably fitted to housing 100 (although housing 100 is not shown in FIGS. 11-14). Moving button 20 rearward to the position of FIG. 12 deflects arm 17 by cam corner 28. Button face 24 comes into contact with bias slide face 44. In FIG. 11A, these faces are spaced from each other as in the stowed position of FIG. 11. After this contact, button 20 moves bias slide 40 rearward. The vertical indicator lines between FIGS. 11 and 12 show the relative changed horizontal positions of button 20 and bias slide 40. By deflecting pusher spring 200 and effecting a reaction force on slide 40 against release button 20, the release button creates a rearward bias on track 30. Described another way, button 20 simply pushes slide 40 and its spring-linked track 30 to the rear. In the exemplary embodiment, pusher spring 200 serves two separate functions: to guide fasteners toward striker 115, and to bias track 30 to pop out upon release. Bias slide 40 may instead include forms that are pivotally and resiliently attached to track 30 (not shown), such forms being equivalent in function. Optionally a separate spring, either linear or torsion, may similarly serve for the pop out bias.

The bias slide described above contrasts with conventional designs that have a biasing element anchored to the housing. In the present exemplary embodiment, the bias is applied to the track only when button 20 is moved. When the track 30 is pressed forward near and to its stowed position, the bias slide does not push to resist this action since it is active only when button 20 is pressed rearward. Described another way, bias slide 40 is selectively active only when it is useful. On the other hand, with conventional track biasing designs, the track is always biased rearward when the track is at near the track stowed position. This bias adds to the force of engaging a catch type structure. Especially when a full rack of staples is loaded there will be the two resisting forces described and a third separate resisting force from the fully deflected pusher spring, the pop out force described above. These combined resistive forces can make the conventional track designs most difficult and resistant for the user to press to a stowed position.

As seen in FIGS. 4 and 10, track pull 10 preferably includes a chamfer to form a relatively sharp edge 13. This edge 13 facilitates grasping to pull out the track 30 from its initial pop out position, which might be near an obstruction formed by the housing rear. But as discussed above, the pop out feature ensures that the track pull is not so near the housing to be difficult to grasp. This is advantageous in working conditions at a construction site, for example, where work gloves are worn that make it difficult to precisely manipulate a tool. Track pull 10 is preferably formed of plastic polymer material such as nylon, acetal, or other suited materials. Optionally, arm 17 may be a separate component movably attached and to a main structure of track pull 10, whereby the track pull 10 may be formed of metal or other rigid material.

Release button 20 likewise may preferably be made from a low friction plastic material. The button 20 slides substantially horizontally on posts 23 and 25 (FIG. 10), within slots 123 and 125, in FIG. 3. As shown, button 20 and arm 17 occupy a space below the track 30. Since the motion of button 20 is linear and not substantially vertical, the action fits in the small space shown whereby the housing 100 extends only slightly below the track in this area, FIG. 2. The fastening tool thus remains compact in this respect.

In an alternative embodiment (not shown), button 20 may pivot about post 25 with cam corner 28 moving upward and the cam corner 28 pressing upward on cam face 11a. Track latch arm 17 is deflected in a similar manner as described above and the track is released. With this structure, sufficient space is provided between the button and the bottom of the track for the vertical motion of the button.

Optionally, arm 17 or equivalent structure may present an operative feature, rib, extension or similar structure on the bottom of the tool. For example, a location near the indication 121 in FIG. 2 may include an opening in the housing to expose a downward protruding button of arm 17 (not shown). This button would be pressed upward into track chamber 102 in FIG. 2 (down in FIG. 5) to deflect arm 17 and disengage catch 11 from mating rib side 107. As above for consistency, the direction of pressing is referred to as inward to comport to both upward in FIG. 1 and downward in FIG. 5. The protruding button is then directly moved rearward to extend the track to its open position. This design would provide a functional system. With the preferred embodiment instead including separate and horizontally movable button 20, there is added protection from accidental track openings. For example, if the tool is in use and pressed against a work surface at the rear, button 20 may be pushed into the track chamber by, for example, a lump in such work surface. Button 20 is pressed but will not engage cam face 11a of arm 17 since the button must slide rearward to do that.

In contrast, a directly actuated button of arm 17 can unintentionally actuate if pressed by the work surface lump. In particular, when the track is full with a staple rack, the track ejecting bias will be strong as discussed above. There is a possibility that the track will pop out and staples will fall out onto the work surface. If the alternative button of arm 17 is recessed enough in the housing or other structure or otherwise protected, then accidental actuation may be minimized.

A feature of the exemplary embodiment further includes a jam protection structure. In case of a staple jam or irregular operation, a staple may become wedged at striker 115 in front of track 30. To prevent potential damage, it is preferable that track 30 can retract a small distance rearward, for example, a staple wire width or two to reduce the force of wedging at the jam. Exemplary track pull 10 preferably includes a built-in structure that provides for this function. In FIG. 10, flexible or resilient bias arm 12 extends downward. Tab 12a of the arm extends outward. Exemplary arm 12 is preferably formed of a same material as track pull 20. Being molded together provides that arm 12 does not require an additional component while the plastic material of arm 12 may be resilient. The operation of these features is shown by comparing FIGS. 6 and 9. FIG. 6 shows a normal stowed condition of the track assembly. Bias arm 12 points substantially downward. Tabs 12a lightly press a rear edge of track 30. Pin 10a is held at a rear extent of track slot 31 under the light pressing by arm 12. See also FIG. 10 for the fit of pin 10a in track pull 10. In FIG. 9, track 30 is forced rearward by a jam at front, typically near striker 115. Arm 12 deflects as shown; pin 10a moves forward relative to slot 31 as the track moves rearward and the track pull stays in position by catch 11 engaging side rib 107. Track pull 10 is guided by upper and lower ribs 14 and 14b to slide along track 30 in this action. A gap is seen at edge 14a (FIG. 6) with this gap closed (FIG. 9) as the track has moved. Extension 18 (FIGS. 6 and 10) spans the gap at 14a on top. Chamfers at 18 and 18a terminate the top front of track pull 10. With chamfered extension 18, staples will not become stuck in the gap in front of edge 14a on track 30 in this area while the extension can move into a space of track 30 as shown hidden in FIG. 9.

Tabs 12a are located at a bottom of arm, or generally preferably toward a bottom of track pull 10. Being closer to the vertical level of catch 11 reduces a torque generated from the force of arm 12. For example, if track 30 were to press tabs 12a rearward at a top of the track (not shown) and catch 11 is pressed forward at the bottom as shown, track pull 10 will be strongly biased to rotate counterclockwise. Track 30 then would not easily slide upon guide ribs 14 and 14b rather becoming wedged to an extent. Therefore, as shown, tabs 12a are at a lowest practical position to counter act the force at catch 11 at a closer vertical position. Accordingly, a torque on track pull 10 is low enough that track 30 can reliably slide upon track pull 10 during the jam event. Edge 14a provides a stop limit for motion of track 30 upon track pull 10. Optionally, slot 31 may be sized that pin 10a contacts a front of the slot to provide a limit. Other stop limits may be included.

It is a feature of the preferred embodiment that a user is inclined if not forced to release and open the track from the upside-down position of FIG. 5. The user is then readily directed to load staples correctly in front of the track into track chamber 102. However, it is still possible a user may improperly try to load staples atop a rear of track 30 as it is extended. For example, in FIG. 5, the tool may be moved upside right while the user attempts to place staples on the rearward extending portion of the track and then attempts to close the track with the staples thereon. To help redirect the user, as best seen in FIG. 14, track pull 10 is preferably narrow for most of its height. Specifically, track pull 10 does not extend past a width of track 30. With this preventative structure, staples can slide off a rear of the track. In a related structure, opening 127 at least in part fits closely to the track width. Therefore, when a user tries to close the track with staples incorrectly loaded on it, the staples will slide off or at least press the hand and cannot enter a cavity of the tool. This clearly indicates to the user that there is no way to install the staples in this manner.

Conventional track pulls are wider than the track. When used incorrectly in a bottom loading tool as described, the conventional wide track pull will help force the staples forward which can wrongly reinforce that this is a correct solution. With the combination of blocking at the housing rear and sliding off the track rear, a misguided user will quickly look to other solutions for loading staples. This is an improvement over conventional designs that do not effectively redirect a user from the incorrect loading methods.

As seen in FIG. 2, the track pull, button and associated structure effectively visually seal within the lower rear of the body with no gaps, dark recesses, openings or other features suggestive of a staple exit location. Tab 22 is one example of a feature that seals an opening. This can improve the user's visual perception and keep the rear compact in a rear action tool as illustrated.

However, with a forward action tool (not shown), this feature has a specific further purpose. A forward action tool has the handle hinged near a rear of the body with the handle pressed near a front of the body over the staple exit location. With a forward action tool, a user must understand how it functions, in particular where the staple exits. A well-designed tool will direct the user accordingly. But redundant direction information is preferred. One such redundancy is the present sealed track pull area. There is no observable way for staples to exit. Further, there are no visible track pull features from the side view. The lack of relevant staple installing features in the rear area will teach a misdirected user to look elsewhere, including a front end that with a striker 115 and corresponding recesses and features that indicate the staple exit function. These features have been demonstrated empirically to work as intended to cause a user who is looking at the tool bottom to discover the front end exit area.

The preceding references to bottom, lower, up, down, etc. are with respect to the upright position shown in FIG. 1. For example, in FIG. 5 with the tool inverted, the top of the view shows the bottom or underside of the tool. While the exemplary track pull assembly is shown in association with a bottom loading tool design, the track pull will be of benefit to any tool which has an extendable magazine or equivalent structure. For example, a track may extend forward from a stowed position in a track chamber. The track chamber need not be open to a bottom; a staple magazine or other loading structure may install into a cavity or track chamber at a front or rear end of the tool above a bottom enclosure of the housing.

While the particular forms of the invention have been illustrated and described, it will be apparent that various modifications can be made without departing from the spirit and scope of the invention. It is contemplated that elements from one embodiment may be combined or substituted with elements from another embodiment.

What is claimed is:

1. A fastening tool, comprising:
a tool housing body including a track chamber;
a track disposed along a bottom of the tool housing body, the track extending within the track chamber, the track including a stowed position under the tool housing body and an open position extending rearward from the track chamber;
a track pull attached to a rear end of the track to form an assembly of the track and track pull, the track pull including a latched position to hold the track in the stowed position and to prevent the track from moving to the extended position;
a resilient arm of the track pull including a catch, the catch selectively engaging the tool housing body in the latched position; and
a release button exposed and movable on a bottom of the fastening tool, the button normally operable to unlatch the track exclusively from a bottom face of the fastening tool, wherein such operable features of the button are visible only when the fastening tool is viewed from below.

2. The fastening tool of claim 1, wherein the release button is separately movable from the track pull.

3. The fastening tool of claim 2, wherein the release button is slidable along the bottom of the tool including a sliding engagement with the arm of the catch, the button including a stowed position and an actuated position, and moving the button from the stowed position to the actuated position deflects the arm to disengage the catch.

4. The fastening tool of claim 1, wherein the release button is actuated from an interface location of the button below a bottom of the track.

5. The fastening tool of claim 1, wherein the release button is pressed inward toward a track chamber and the track pull is slidable rearward after the button is pressed.

6. The fastening tool of claim 5, wherein the release button remains forward of a rear of the housing as the track pull moves rearward to fully extend the track rearward of the housing.

7. The fastening tool of claim 3, wherein the actuated position includes a cam corner of the button pressing a cam face of the resilient arm to deflect the arm.

8. The fastening tool of claim 1, wherein the track pull is attached to a rear of the track and the track pull moves with the track as the track extends rearward to an opened position.

9. The fastening tool of claim 8, wherein the track pull is in the latched position, and wherein the track pull includes a flexible track bias arm, the bias arm normally presses forward on the track, the bias arm flexes to allow the track to move a limited distance rearward in relation to the track pull from the operative stowed position, and the bias arm biases the track to return to the stowed position.

10. The fastening tool of claim 9, wherein the track pull comprises a flexible plastic material, and the track bias arm is molded of a same piece of polymer material as a main structure of the track pull.

11. The fastening tool of claim 3, wherein the release button slides rearward to disengage the catch, a bias slide is fitted to the track and biased to move forward on the track, the bias slide selectively engaged to the button whereby moving the button causes a rearward bias on the track through the bias slide.

12. The fastening tool of claim 10, wherein a pusher spring is connected at a first end to a pusher to guide fasteners on the track toward a front of the tool, a second end of the pusher spring is connected to the bias slide wherein the pusher spring serves to bias both the bias slide and the pusher.

13. A fastening tool, comprising:
a tool housing body including a track chamber;
a track disposed along a bottom of the tool housing body, the track extending within the track chamber, the track including a stowed position under the tool housing body and an open position extending rearward from the track chamber;
a track pull attached to a rear end of the track to form an assembly of the track and track pull, the track pull including a latched position to hold the track in the stowed position and to prevent the track from moving to the extended position;
a resilient arm of the track pull extending forward under the track and including a catch, the catch selectively engaging the housing in the latched position;
a release button exposed and movable on a bottom of the fastening tool below the track, wherein the button includes a forward stowed position and a rearward position, the button normally operable to unlatch the track from a bottom face of the tool; and
the button fitted substantially entirely between a bottom of the track and a lowermost bottom of the tool housing body at a location of the button.

14. The fastening tool of claim 13, wherein operable features of the button are visible exclusively from a bottom view of the fastening tool.

15. The fastening tool of claim 13, wherein the button includes a recess and the recess provides an interface to move the button rearward.

16. The fastening tool of claim 13, wherein the track pull is a same width as the track near an upper location of the track pull.

17. The fastening tool of claim 13, wherein the release button selectively engages the resilient arm to deflect the arm and disengage the arm from the housing.

18. The fastening tool of claim 17, wherein the release button slidably engages a cam face of the resilient arm to deflect the arm.

19. The fastening tool of claim 13, wherein the track pull and button fit to the housing without gaps to visually seal the lower rear of the body at a location of the track pull and button.
